(19) United States
(12) Patent Application Publication
(10) Pub. No.: US 2013/0016060 A1
(43) Pub. Date: Jan. 17, 2013

(54) ELECTRONIC DEVICE AND METHOD OF CONTROLLING A TOUCH-SENSITIVE DISPLAY

(71) Applicants: Mykola GOLOVCHENKO, Sunnyvale, CA (US); William Turlay STACY, San Jose, CA (US)

(72) Inventors: Stanislav PEREVERZEV, Sunnyvale, CA (US); Mykola GOLOVCHENKO, Sunnyvale, CA (US); William Turlay STACY, San Jose, CA (US)

(73) Assignee: RESEARCH IN MOTION LIMITED, Waterloo (CA)

(21) Appl. No.: 13/180,917

(22) Filed: Jul. 12, 2011

(51) Int. Cl. G06F 3/045

(52) U.S. Cl. 345/174

(57) ABSTRACT

A device includes a touch sensor, and at least one electrode spaced from touch sensor by an air gap, wherein a change in capacitance between the touch sensor and the electrode is utilized to determine a value related to a force imparted on the device.

### FIELD OF TECHNOLOGY

The present disclosure relates to electronic devices including but not limited to portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones, wireless PDAs, and laptop computers with wireless 702.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. Improvements in devices with touch-sensitive displays are desirable.

### BRIEF DESCRIPTION OF THE DRAWINGS

FIG. 1 is a block diagram of a portable electronic device in accordance with the present disclosure.

FIG. 2 is a sectional side view of a portable electronic device including a touch-sensitive display in accordance with the disclosure.

FIG. 3 is a partial cross-section of the touch-sensitive display in accordance with the disclosure.

FIG. 4 is a sectional side view illustrating a force applied to the touch-sensitive display in accordance with the disclosure.

FIG. 5 is a flowchart illustrating a method of detecting a force applied to the touch-sensitive display in accordance with the disclosure.

FIG. 6 is a sectional side view of another portable electronic device including a touch-sensitive display in accordance with the disclosure.

FIG. 7 is a partial cross section of a portion of the touch-sensitive display in accordance with the disclosure.

FIG. 8 is a sectional side view illustrating a force applied to the touch-sensitive display in accordance with the disclosure.

### DETAILED DESCRIPTION

The following describes an electronic device including a touch sensor, and at least one electrode spaced from touch sensor by an air gap, wherein a change in capacitance between the touch sensor and the electrode is utilized to determine a value related to a force causing bending of the touch sensor.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, such as a portable electronic device as described herein. Examples of electronic devices include mobile, or handheld, wireless communication devices such as pagers, cellular phones, cellular smart-phones, wireless organizers, personal digital assistants, wirelessly enabled notebook computers, tablet computers, mobile internet devices, and so forth. The electronic device may be a portable electronic device without wireless communication capabilities, such as a handheld electronic game, digital photograph album, digital camera, media player, e-book reader, and so forth.

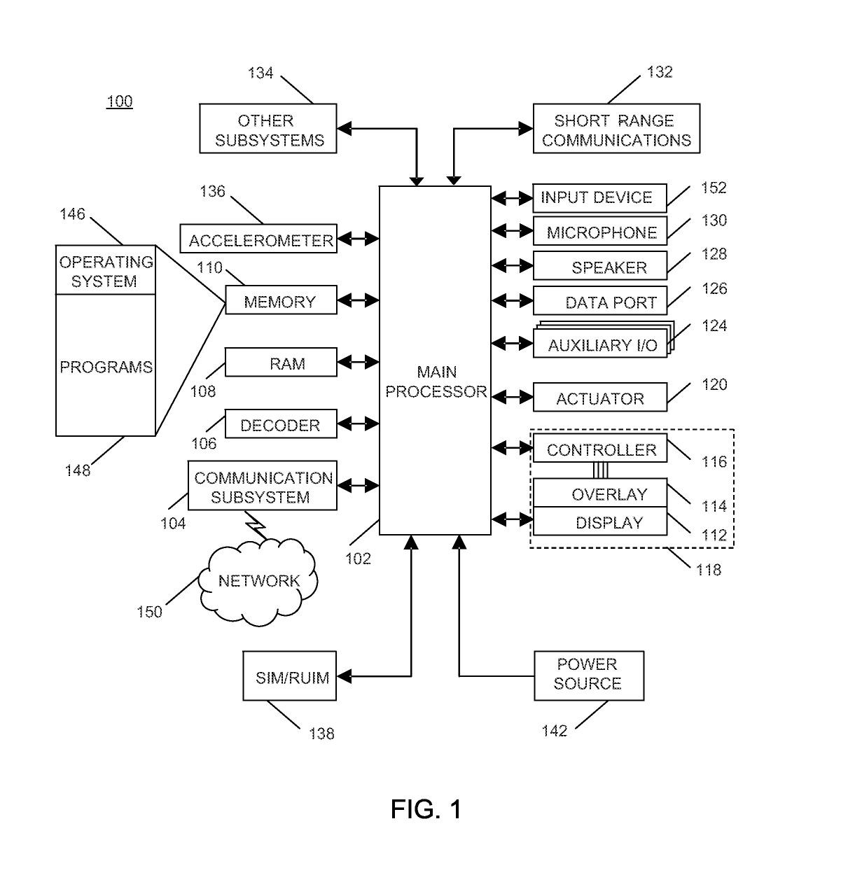

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, an auxiliary input/output (I/O) subsystem 124, a data port 126, a speaker 128, a microphone 130, short-range communications 132, and other device subsystems 134. Input via a graphical user interface is provided via the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may optionally interact with one or more actuators 120. The processor 102 may also interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

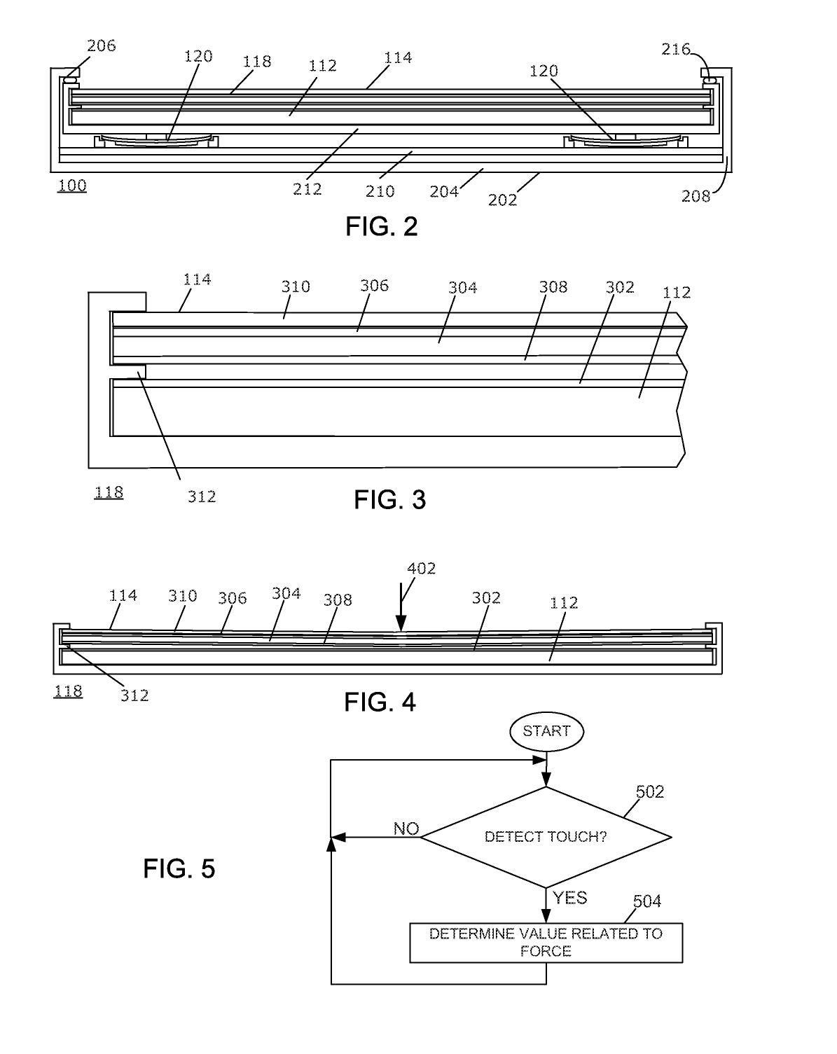

A cross section of a portable electronic device 100 including the touch-sensitive display 118 is shown in FIG. 2. The portable electronic device 100 includes a housing 202 that encloses components such as shown in FIG. 1. The housing 202 may include a back 204, sidewalls 208, and a frame 206 that houses the touch-sensitive display 118. A base 210 extends between the sidewalls 208, generally parallel to the back 204, and supports the actuators 120. The display 112 and the overlay 114 are supported on a support tray 212 of suitable material, such as magnesium. Optional spacers 216 may be located between the support tray 212 and the frame 206, may advantageously be flexible, and may also be compliant or compressible, and may comprise gel pads, spring elements such as leaf springs, foam, and so forth.

The display 112 may be any suitable display such as, for example, a liquid crystal display (LCD) or an organic light emitting diode (OLED) display. An LCD may include, for example, a backlight, liquid crystal disposed between positive and negative electrodes, polarizers, filters, and a cover, such as a glass cover.

The overlay 114 may be an assembly of multiple layers in a stack including, for example, one or more capacitive touch sensor layers separated by a substrate or other barrier, and a cover.

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. A signal is provided to the controller 116 in response to detection of a touch. A touch may be detected from any suitable input member, such as a finger, thumb, appendage, or other items, for example, a stylus, pen, or other pointer, depending on the nature of the touch-sensitive display 118. The controller 116 and/or the processor 102 may detect a touch by any suitable input member on the touch-sensitive display 118. Multiple simultaneous touches may be detected.

The optional actuator(s) 120 may be depressed by applying sufficient force to the touch-sensitive display 118 to overcome the actuation force of the actuator 120. The actuator 120 may be actuated by pressing anywhere on the touch-sensitive display 118. The actuator 120 may provide input to the processor 102 when actuated. Actuation of the actuator 120 may result in provision of tactile feedback. Other different types of actuators 120 may be utilized than those described herein.

A mechanical dome switch actuator may be utilized and tactile feedback may be provided when the dome collapses due to imparted force and when the dome returns to the rest position after release of the switch.

Alternatively, the actuator(s) 120 may comprise one or more piezoelectric (piezo) devices that provide tactile feedback for the touch-sensitive display 118. Contraction of the piezo actuator(s) applies a spring-like force, for example, opposing a force externally applied to the touch-sensitive display 118. Each piezo actuator includes a piezoelectric device, such as a piezoelectric ceramic disk adhered to a substrate, such as a metal substrate. The substrate bends when the piezoelectric device contracts due to build up of charge/voltage at the piezoelectric device or in response to a force, such as an external force applied to the touch-sensitive display 118. The charge may be varied by varying the applied voltage/current, thereby controlling the force applied by the piezo actuators. The charge/voltage may be removed by a controlled discharge voltage/current to decrease the force applied by the piezo actuators 120. The charge/voltage may advantageously be removed over a relatively short period of time to provide tactile feedback to the user.

A partial cross section of the touch-sensitive display 118 is shown in FIG. 3. In the example illustrated in FIG. 3, a ground shield 302 is disposed on the display 112. The ground shield 302 may be, for example, an electrode such as a transparent thin film conductive coating or a fine distribution of electrodes such as a patterned conductive layer of, for example, indium tin oxide (ITO). The ground shield 302 is disposed on the display 112 to protect the display from electrostatic discharge, for example.

The touch-sensitive overlay 114 includes a substrate 304, which may comprise glass or plastic. An upper set of touch-sensing electrodes 306 is disposed on a top side of the substrate 304 and a lower set of touch-sensing electrodes 308 is disposed on the bottom side of the substrate 304. The upper set of touch-sensing electrodes 306 may be, for example, ITO deposited on the top side of the substrate 304. The lower set of touch-sensing electrodes 308 may be ITO deposited on the bottom side of the substrate 304. The term deposited refers to vapor deposition or a similar process. The upper set of touch-sensing electrodes 306 are separated from the lower set of touch-sensing electrodes 308 by the substrate 304. The upper and lower sets of touch-sensing electrodes 306, 308 may, for example, act as receiver and transmitter electrodes to detect a touch on the touch-sensitive display 118. The cover 310 is disposed on the upper set of touch-sensing electrodes 306 to protect the electrodes 306. The cover 310 may comprise glass or plastic. The terms upper, lower, top, and bottom are utilized herein for reference only, refer to the orientation of the electronic device 100 as illustrated in the figures, and are not otherwise limiting.

The touch-sensitive overlay 114 is supported on a rigid support 312 disposed between the display 112 and the substrate 304 such that the ground shield 302 is spaced from the lower set of touch-sensing electrodes 308 by an air gap. The rigid support 312 may be a continuous support that the outer margin of the substrate 304 is disposed on. Alternatively, the rigid support 312 may comprise a plurality of supports on which the substrate 304 is disposed. The rigid support 312 may be part of the support tray 212 or may be inserted on the display 112. The rigid support 312 may be any suitable material, such as plastic or metal, sufficient to support the substrate 304 and sufficient to inhibit movement of the sides of the substrate 304 toward the ground shield 302 disposed on the display 112.

A force, such as the force illustrated by the arrow 402 in FIG. 4, applied to the touch-sensitive display 118 may cause bending of the substrate 304 and the upper and lower sets of touch-sensing electrodes 306, 308. Such bending of the substrate 304 reduces the distance between the lower set of touch-sensing electrodes 306 and the ground shield 302. Although the change in distance between the lower set of touch-sensing electrodes 308 and the ground shield 302 may be slight, the change is detected by measuring changes in capacitance between the lower set of touch-sensing electrodes 308 and the ground shield 302. The change in capacitance is utilized to determine a value related to the applied force. The value related to the force may be based on the change in capacitance or may be based on both location of the touch and the change in capacitance. For example, bending of the substrate 304 may be greater when a force is applied near a center of the touch-sensitive display 118 compared to an equivalent force applied near a side of the touch-sensitive display 118. The change in distance between the lower set of touch-sensing electrodes 306 and the ground shield 302 is greater when the force is applied at near the center of the touch-sensitive display than when the force is applied near the side. The value related to the force may be determined based on the location of the touch to account for this difference in the change of distance.

The change in capacitance is proportional to the deflection of the substrate 304 during bending, and the deflection is dependent, for example, on the force and the location of the touch on the touch-sensitive display 118. The location is determined utilizing the touch-sensing electrodes 306, 308. The force, or a value related to the force, may be identified utilizing the measured change in capacitance and the location of the touch to identify an associated force value.

The force may be identified utilizing a table including force values and associated capacitance values for various touch locations. The table may be obtained experimentally during manufacture of the portable electronic device or a similar portable electronic device, for example. To obtain the table experimentally, forces of known values may be applied at locations on the touch-sensitive display and the capacitance determined for each force value at each location to associate the capacitance to the force value for each location. Alternatively, the table may be obtained by modeling, such as finite element modeling, to associate applied force with deflection of the touch-sensitive display based on location and based on known equations or relations associating capacitance with deflection.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

A flowchart illustrating a method of detecting a force applied to the touch-sensitive display is illustrated in FIG. 5. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

When a touch is detected 502 utilizing signals from the upper and lower sets of touch-sensing electrodes 306, 308, measured changes in capacitance between the lower set of touch-sensing electrodes 308 and the ground shield 302 are utilized to determine 504 a value related to the force of the touch. During touch detection, the touch-sensing electrodes 306, 308 are utilized to detect the touch and the ground shield 302 shields the touch-sensing electrodes 306, 308 from interference. The controller 116 may switch the upper set of touch-sensing electrodes 306 to couple the upper set of touch-sensing electrodes to a ground during measurement of capacitance between the lower set of touch-sensing electrodes 308 and the ground shield 302. The controller 116 controls the upper set of touch-sensing electrodes to switch between sensing and ground connections.

For example, a scan of the touch screen utilizing the electrodes 306, 308 to detect touches may be followed by a determination of the change, if any, in capacitance between the lower set of touch-sensing electrodes 308 and the ground shield 302. The change in capacitance that results from a force causing bending of the substrate 304 and the touch-sensing electrodes 306, 308 may be utilized to determine a value related to the applied force. The determination of the change in capacitance is not carried out during touch detection.

Within the stack, the locations of the electrodes 306, 308 and the ground shield 302 are described to provide an example and other locations may be successfully implemented. For example, the upper set of touch-sensing electrodes may be disposed on a bottom side of the cover 310. Alternatively, a single set of touch-sensing electrodes may be utilized to detect the touch.

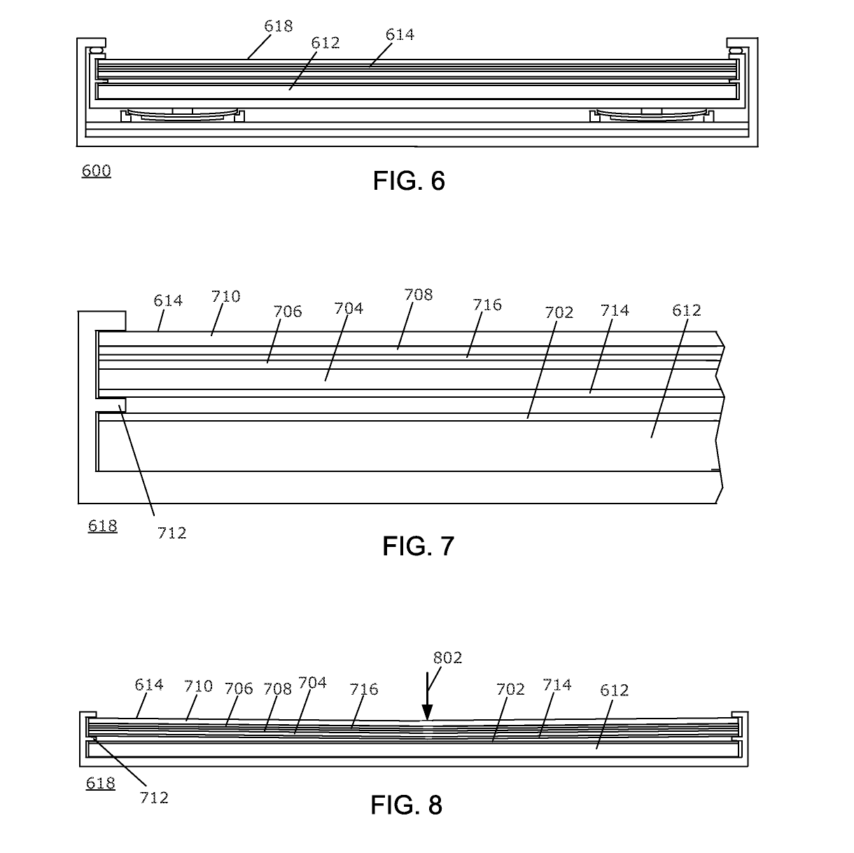

A cross section of another portable electronic device 600 including a touch-sensitive display 618 is shown in FIG. 6. The touch-sensitive display 618 includes a touch-sensitive overlay 614 disposed on a display 612 and supported by a support tray. Many of the components and features of the portable electronic device 600 are similar to those described above for the portable electronic device 100.

A partial cross section of the touch-sensitive display 618 is shown in FIG. 7. In this example, a ground shield 702 is disposed on the display 112. The ground shield 702 is disposed on the display 112 to protect the display from electrostatic discharge.

The touch-sensitive overlay 614 includes a substrate 704, which may comprise glass or plastic. A force-sensing electrode 714 is disposed, for example, on a bottom side of the substrate 704, facing the display 612. The force-sensing electrode 714 may be a single electrode, such as a plate, disposed on the substrate 704 or may be a plurality of electrodes distributed on the bottom side of the substrate 704.

A set of touch-sensing electrodes 708 is disposed on a top side of the substrate 704. A further set of touch-sensing electrodes 706 is disposed on a bottom side of the cover 710. The cover 710 may be adhered to the substrate 704 utilizing a dielectric adhesive 716 such that the touch-sensing electrodes 606 disposed on the bottom side of the cover 710 are separated from the touch-sensing electrodes 708 disposed on the substrate 704. The cover 310 may comprise glass or plastic. The touch-sensing electrodes 706, 708 are utilized to detect a touch and determine a location of the touch on the touch-sensitive display 118.

The touch-sensitive overlay 614 may be supported on a rigid support 712 disposed between the display 612 and the substrate 704 such that the ground shield 702 is spaced from the touch-sensing electrodes 708 by an air gap. The support 712 may be a continuous support that the outer margin of the substrate 704 is disposed on or may comprise, for example, a plurality of spaced apart supports on which the substrate 704 is disposed. The support 712 may be part of the support tray or may be inserted on the display 612.

A force, such as the force illustrated by the arrow 802 in FIG. 8, applied to the touch-sensitive display 618 may cause bending of the cover 710 and the substrate 704. When the cover 710 and the substrate 704 bend, the force-sensing electrode 714 also bends, reducing the distance between the force-sensing electrode 714 and the ground shield 702. The reduction in distance change is detected by detecting changes in capacitance between the force-sensing electrode 714 and the ground shield 702.

During touch detection, the touch-sensing electrodes 708, 706 are utilized to detect the touch and the ground shield 702 shields the touch-sensing electrodes 708, 706 from interference from the display 612. The upper set of touch-sensing electrodes 708 may be grounded during measurement of capacitance between the force-sensing electrode 714 and the ground shield 702.

A value related to an applied force may be determined by determining the change in capacitance between electrodes. The electrodes that are utilized are separated by an air gap and the change results from the applied force causing bending of one of the electrodes and the substrate, which may comprise glass or plastic. The air gap provides protection to the display from damage caused by excessive force imparted on the touch-sensitive overlay. The air gap is advantageous over a compressible medium or elements that may not recover from compression at a suitable rate. For example, compressible medium or elements may be very slow to recover at temperatures below room temperature. A force-sensing electrode and touch-sensing electrodes may be disposed on a substrate and may be disposed on a cover, rather than utilizing a further substrate.

A device includes a touch sensor and at least one electrode spaced from touch sensor by an air gap, wherein a change in capacitance between the touch sensor and the electrode is utilized to determine a value related to a force causing bending of the touch sensor. A method includes detecting a touch utilizing a touch sensor of a touch-sensitive display, and utilizing a change in capacitance between the touch sensor and the electrode to determine a value related to a force causing bending of the touch sensor. An electronic device includes a display, an electrode disposed on the display, and a touch sensor spaced form the at least one electrode by an air gap, wherein a change in capacitance between the electrode and the touch sensor is utilized to determine a value related to a force. A device includes a substrate having a first side and second side, a first set of touch-sensing electrodes disposed on the first side of the substrate, a force-sensing electrode disposed on the second side of the substrate, and a display including a ground shield. A change in capacitance between the force sensing electrode and the ground shield is utilized to determine a value related to a force imparted on the device.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A device comprising:
a first sensor;
an electrode spaced from the first sensor by an air gap;
wherein a change in capacitance between the first sensor and the electrode are utilized to determine a value related to a force causing bending of the first sensor.

2. The device according to claim 1, wherein the first sensor is disposed on a substrate and bending of the first sensor comprises bending of the substrate.

3. The device according to claim 1, wherein the first sensor comprises at least one set of touch-sensing electrodes disposed on a substrate and bending of the first sensor comprises bending of the substrate.

4. The device according to claim 1, wherein the first sensor comprises a first set of touch-sensing electrodes and second set of touch-sensing electrodes disposed on opposing sides of a substrate.

5. The device according to claim 1, wherein the first sensor comprises a substrate supported at sides thereof to inhibit movement of the sides toward the at least one electrode when the force is imparted on the device.

6. The device according to claim 1, wherein the at least one electrode comprises a ground shield disposed on a display.

7. The device according to claim 1, wherein the first sensor comprises a capacitive touch sensor.

8. The device according to claim 1, wherein the change in capacitance is caused by a change in distance between the first sensor and the electrode.

9. The device according to claim 1, comprising a display on which the at least one electrode is disposed.

10. The device according to claim 1, wherein the first sensor comprises a force-sensing electrode disposed on a side of a substrate.

11. The device according to claim 10, comprising a first set of touch-sensing electrodes on an opposite side of the substrate and a second set of touch-sensing electrodes on a side of a cover, the first set of touch-sensing electrodes and the second set of touch-sensing electrodes separated by a dielectric adhesive.

12. A method comprising:
detecting a touch utilizing a touch sensor of a touch-sensitive display;
utilizing a change in capacitance between the touch sensor and at least one electrode to determine a value related to a force causing bending of the touch sensor.

13. The method according to claim 12, wherein the change in capacitance is caused by a change in distance between the first sensor and the electrode.

14. The method according to claim 12, wherein bending of the touch sensor comprises bending of a substrate including touch-sensing electrodes disposed thereon.

15. The method according to claim 12, wherein bending of the touch sensor comprises bending of a glass substrate including touch-sensing electrodes disposed thereon.

16. An electronic device comprising:
a display;
at least one electrode disposed on the display;
a first sensor spaced form the at least one electrode by an air gap;
wherein a change in capacitance between the first sensor and the at least one electrode is utilized to determine a value related to a force causing bending of the first sensor.

17. The touch-sensitive display according to claim 16, wherein the first sensor is disposed on a substrate and bending of the first sensor comprises bending of the substrate.

18. The touch-sensitive display according to claim 16, wherein the first sensor comprises a substrate supported at sides thereof to inhibit movement of the sides toward the at least one electrode when the force is imparted on the device.

19. The device according to claim 1, wherein the at least one electrode comprises a ground shield disposed on the display.

20. The device according to claim 1, wherein the first sensor comprises a force-sensing electrode disposed on a side of a substrate and the device comprises a first set of touch-sensing electrodes on an opposite side of the substrate and a second set of touch-sensing electrodes on a side of a cover, wherein the first set of touch-sensing electrodes and the second set of touch-sensing electrodes are separated by a dielectric adhesive.
